(19) United States
(12) Patent Application Publication
(10) Pub. No.: US 2006/0167937 A1
(43) Pub. Date: Jul. 27, 2006

(54) Internet based geographic information system

(76) Inventor: Timothy Tierney, Santa Barbara, CA (US)

Correspondence Address: MARK RODGERS, 1590 SAN ROQUE ROAD, SANTA BARBARA, CA, 93105, US

(21) Appl. No.: 11/038,607

(22) Filed: Jan. 18, 2005

(51) Int. Cl. G06F 17/00

(52) U.S. Cl. 707/104.1

(57) ABSTRACT

The invention is an Internet based Geographic Information System (GIS), which resides totally on Internet servers, allowing users to access and use the system on the Internet from a browser or equivalent, thus requiring no user installed software. The system provides enough core GIS capability to allow creation of GIS data layers but is user friendly enough to provide access to users who are not GIS specialists. The system supports sharing of data among users, and supports data compatibility with platform based GIS installations.

### RELATED APPLICATIONS

Not Applicable

### FEDERALLY SPONSORED RESEARCH

Not Applicable

### SEQUENCE LISTING

Not Applicable

### BACKGROUND OF THE INVENTION

The invention relates to Geographic Information Systems (GIS), and in particular a GIS which resides on the Internet and provides core GIS capability in a manner user friendly enough to allow access by users who are not GIS specialists.

GIS software deals with map based data, basically associating a wide range of data with location on a map. Associating data with location allows for new and effective means to analyze, correlate, and display data. Typically, GIS software allows for the overlay of data “layers” on a base map layer. Layers include aerial and space based information such as images, infrared and radar data; geological information such as composition, topology or seismic; demographic information, such as population and population characteristics; sensor acquired data, such as air and water quality; and a host of other information. GIS data is now used by business, governmental, and research interests to analyze and display location relevant data. GIS software has traditionally taken the form of platform based applications with very robust functionality for data creation, manipulation, analysis, and visualization.

Current GIS systems fall into two categories. One category is complex and powerful platform based systems that require an expert to use. The other category is simple systems, some of which use in part online resources, which allow for minimal data layering and almost no data creation. This situation restricts the use of GIS methodology, as neither category is useful to the majority of users who have data which can benefit from GIS techniques. The second category is mostly used for pursuits such as real estate analysis and consumer map creation. The first category requires data to be submitted to a GIS expert, a process which is inefficient, time consuming and costly.

A tool is needed that allows users such as field geologists, environmental engineers, civic planners, and the like as well as hobbyists to create their own GIS data layers, and to perform at least a sizable portion of their own data analysis. Moreover, users such as these require tools that are accessible anywhere, even from the field. Thus it is the object of this invention to provide a universally accessible, easy to use, GIS tool with enough core capability to provide an adequate analysis capability for most users. Core GIS functionality is;
Map navigation via zooming and panning
Accessing data organized into layers
Creating “shapefile-equivalent data”
   Shapefile-equivalent data is
Sets of any combination of points, lines or polygons
Any individual feature within a set may have unique attributes
Fully equivalent and convertible to/from GIS shapefiles
   It is another object of the invention to allow non-expert users to create data layers which may be transferred to expert level GIS installations for more complex applications, streamlining the GIS process. It is a further object to allow for user data to be easily shared.

### BRIEF SUMMARY OF THE INVENTION

The invention is a Geographic Information System GIS) including a GIS capable program residing on at least one Internet server. The program accesses cartographic and other data bases from at either or both resident servers and other locations on the Internet. The program provides a user interface to users who access the program from the internet, and the users require no GIS specific software resident on the user platforms, only an internet browser or equivalent.

In one embodiment, the program enables the user to create GIS data layers composed of shapefile-equivalent data. In one version, user created data layers may be stored on at least one server, such that the entire process is online.

In a further embodiment, user created data is compatible with and may be downloaded to user platform resident GIS programs. In another embodiment user created data may be made available to other users.

In a preferred embodiment, the program provides core GIS functionality, including map navigation, viewing of data as discrete layers, and creation of shapefile-equivalent data. In one version, user drawn data is converted to Open-GIS format before being stored on a server. In another version, the program retrieves and displays vector or raster data from one more of private and public data servers. In one aspect, a custom database may be user created, and locations in the user created data may be assigned any number of attributes.

### BRIEF DESCRIPTION OF THE DRAWINGS

The following detailed description of the invention will be better understood by referring to the accompanying figures FIG. 1 illustrates the operation of the invention in relation to the Internet.

FIG. 2 shows how the invention fills a critical need in GIS functionality and usability.

FIG. 3 illustrates utilizing the invention to create data which may be used by platform based GIS installations.

FIG. 4 illustrates how user created data may be shared with other users.

### DETAILED DESCRIPTION OF THE INVENTION

Referring to FIG. 1, the invention is illustrated. Rather than residing on a user platform, the GIS software 2 (commercially called NetMap) of the invention resides on one (or more) Internet 4 server 1. The Software 2 is configured such that it is accessible by Internet 4 browsers or equivalent, from users. Thus multiple users 6 may access the Software 2 simultaneously. The GIS Software 2 may have access to data bases resident on its servers or also may access external data bases 5 over Internet 4. These may include civic, private or research data bases such as Landsat data, aerial photographs, geologic maps, and so on. The Software 2 is configured to interpret a wide variety of data available on the Internet 4 and import and format the data such that the data may be used as a layer in a GIS.

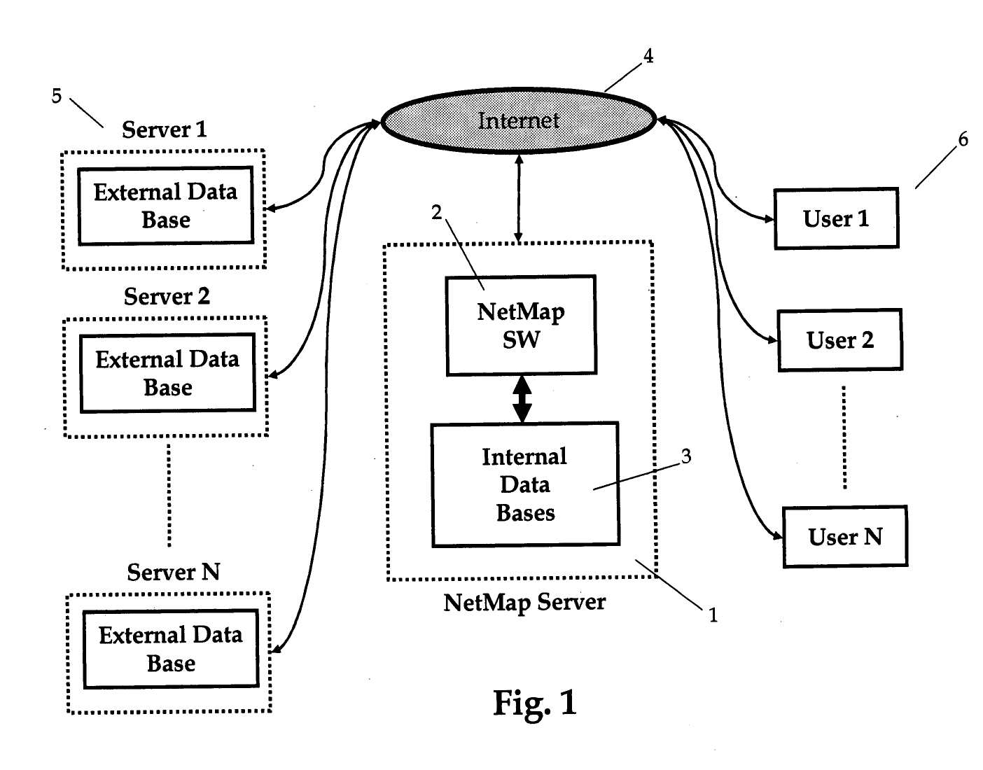

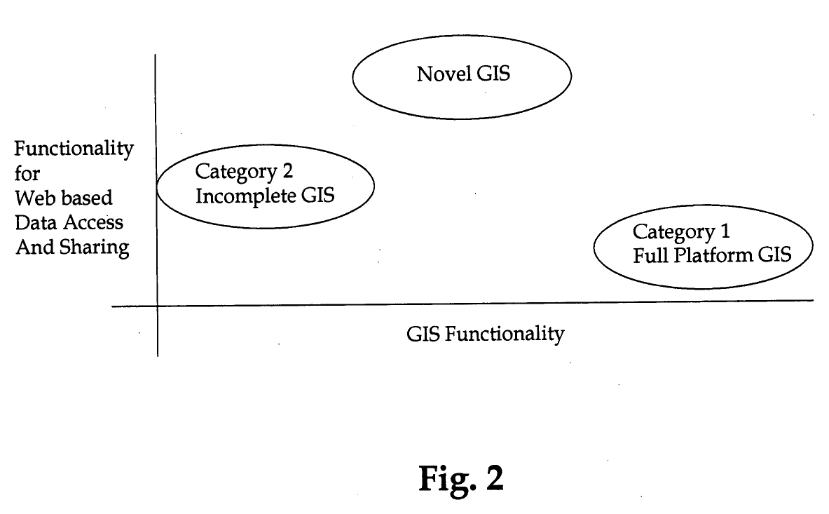

Attempts to provide GIS software via the internet have primarily focused on merely allowing web-users to view content already created with platform GIS. Pseudo-web software (Keyhole, a platform installed application that accesses proprietary web-served data) has appeared that allows a user to do extremely minimal data creation (plotting solitary data points that are saved to the user's local machine), but this falls far short of what platform GIS offers for data-creation and also fails to provide the service entirely via the internet (requiring data to be saved to the local machine). The novel GIS of the invention is fully internet based (no installation required) and provides the “core” functionality common to platform GIS: map navigation, viewing of data as discreet layers, and creation of shapefile-equivalent data (data sets of any combination of attributed points, lines and polygons). Further, user-created data is saved to an online server rather than to a local disk, making the entire process fully online. By offering core-GIS functionality entirely online, the novel GIS goes beyond both category 1 platform GIS and category 2 incomplete GIS efforts, as shown in FIG. 2.

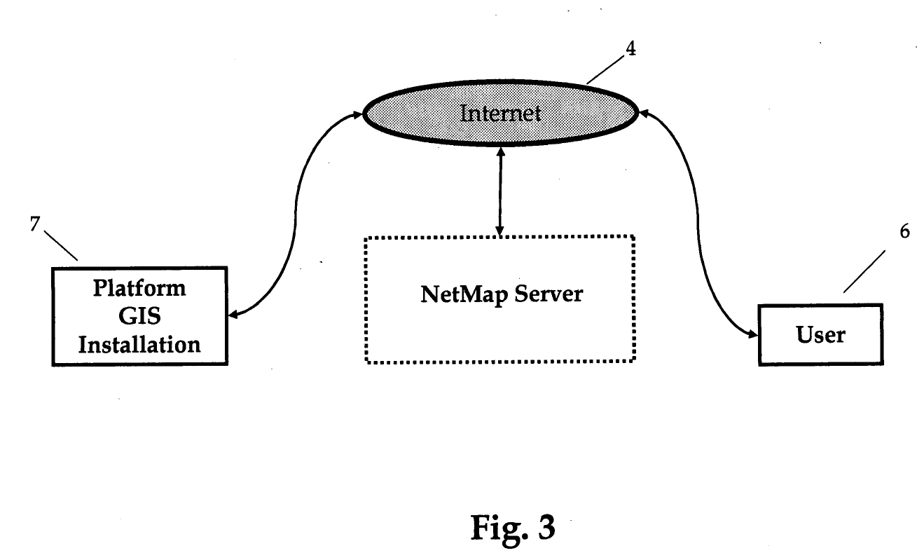

One of the major drawbacks to current GIS is that the fully featured platform based implementations require expert level practitioners. Yet the originators of the data to be analyzed by GIS are experts in other fields such as geology, environmental science, cartography, civic planning and so on. These creators of GIS data usually do not also have the expertise to operate fully featured platform based GIS. The invention, by providing a simplified navigation and data creation user interface, allows for many more users to create GIS data layers. Moreover the fact that the novel GIS resides online, allows users to create and enter data anywhere they have access to the Internet, wired or wireless, even the field. The invention includes the capability to create data that is compatible with platform based GIS installations. Thus, users may create data layers, analyze the data at least partially themselves, or transfer data to expert level platforms for more complex applications. As shown in FIG. 3, the user 6 may accomplish all of this over the Internet 4, if the platform GIS 7 is also connected to the Internet 4. Of course, data may also be transferred by media exchange or other methods as well.

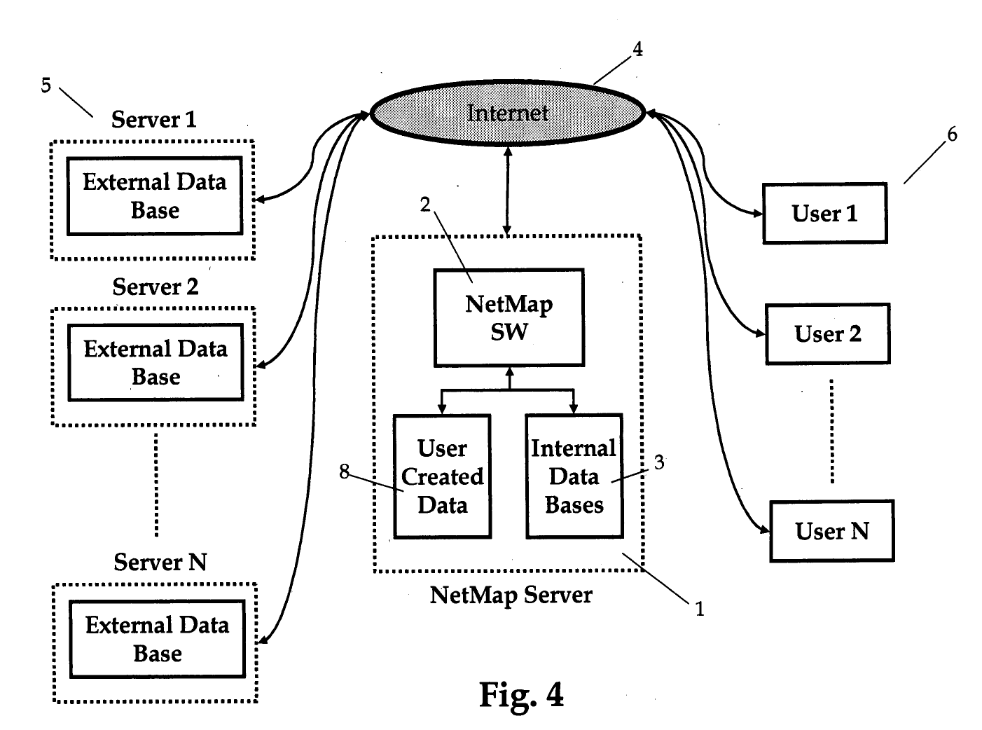

Referring to FIG. 4 another important feature of the novel GIS is illustrated. Because the GIS is fully online resident, user created data 8 may be stored on the server(s) as well. Thus users may allow other users access to their data, promoting data sharing. Platform GIS is known for its difficulty in sharing data among users on different machines, a task that challenges even specialist-users. The novel GIS overcomes this obstacle by storing all data created by users anywhere into a single database following a single standard. Users may share data amongst themselves merely by granting access permissions. Specific major technical problems thus avoided include data corruption on transfer, hard-coded file paths becoming broken, and map reprojection errors.

An actual implementation of the novel GIS, NetMap, will be described. The details of the implementation should not be considered limiting in any way to the scope of the invention. The NetMap system is comprised of a package of files that render the web interface, control user interactions, and control read/write interactions with multiple online databases holding geospatial information. These files are written in Scaleable Vector Graphics (SVG), Javascript (JS), and PHP. The central file in this system is written in SVG, and renders the web interface and calls supporting files for controlling mathematical operations (JS) and database interactions (PHP). The entire file package comprising the NetMAP prototype totals 150 kb in size, representing a minimal browser burden in terms of loading the interface.

The NetMAP interface is fully web-based and cross-platform as a result of being based upon SVG. SVG is a new W3C recommended standard <http://w3c.org/Graphics/SVG/> that operates on MAC (OS8.6 or better), and PC (WIN98 or better), as well as Linux and Solaris and presently runs in all major web browsers (including Internet Explorer, Netscape, Safari) via a free plug-in <http://www.adobe.com/svg/viewer/install/main.html>. Next-generation web browsers will offer native support for SVG. SVG is superior to traditional HTML for online applications because it supports vector as well as raster graphics and is also more easily programmed for interactivity.

NetMAP displays data layers by communicating requests to online data servers which then return either vector or raster data in response. Most NetMAP data is presently from free, public data servers that return raster images (TerraServer-USA <http://terraserver.microsoft.com/> and USGS-Seamless <http://seamless.usgs.gov/>), and includes shaded relief, roads, streams, named places, topographic maps, satellite photography and aerial photography.

Additionally, NetMAP communicates with proprietary data sets hosted on a private data server (a Postgres database hosted on a Unix server) that include both vector (county lines, highways, individual houses) and raster data (shaded relief)—any custom dataset may thus be created for NetMAP. Additionally, these features may bear any number of additional attributes (county polygons may have names, populations, etc) displayable through NetMAP.

User-drawn data is stored as SVG draw-statements in the browser's memory buffer until submitted for storage, at which point it is converted on the user-side to Open-GIS format <http://www.opengeospatial.org/> and stored in a MySQL database hosted on a Unix server. This data can later be reconverted into SVG (for redisplay in NetMAP as a custom dataset) or into other formats, such Shapefiles (SHP) for use in platform based GIS applications.

The implementation as described is extendible to allowing users to upload their own raster data to NetMAP servers, and allowing users to move beyond data creation and into data analysis.

I claim:

1. A Geographic Information System (GIS), comprising a GIS capable program residing on at least one Internet server, wherein;
the program accesses cartographic and other data bases from at least one of the resident servers and/or from other locations on the Internet,
the program provides a user interface to users who access the program from the internet; and,
the users require no GIS specific software resident on the user platforms, only an internet browser or equivalent.

2. The GIS of claim 1 wherein the program enables the user to create GIS data layers composed of shapefile-equivalent data.

3. The GIS of claim 2 wherein user created data layers may be stored on at least one server, such that the entire process is online.

4. The GIS of claim 2 wherein user created data is compatible with and may be downloaded to user platform resident GIS programs.

5. The GIS of claim 3 wherein user created data may be made available to other users.

6. A Geographic Information System (GIS), comprising a GIS capable program residing on at least one Internet server, wherein;
the program accesses cartographic and other data bases from at least one of the resident servers and from other locations on the Internet,
the program provides a user interface to users who access the program from the Internet,
the users require no GIS specific software resident on the user platforms, only an Internet browser or equivalent; and,
the program provides core GIS functionality, including map navigation, viewing of data as discrete layers, and creation of shapefile-equivalent data.

7. The GIS of claim 6 wherein the program enables the user to create GIS data layers composed of shapefile-equivalent data.

8. The GIS of claim 7 wherein user created data layers may be stored on at least one server, such that the entire process is online.

9. The GIS of claim 8 wherein user created data is compatible with and may be downloaded to user platform resident GIS programs.

10. The GIS of claim 8 wherein user created data may be made available to other users.

11. The GIS of claim 9 wherein user drawn data is converted to Open-GIS format before being stored on a server.

12. The GIS of claim 6 wherein the program retrieves and displays vector or raster data from one more of private and public data servers.

13. The GIS of claim 6 wherein a custom database may be user created and locations in the user created data may be assigned any number of attributes.
